(19) United States
(12) Patent Application Publication
(10) Pub. No.: US 2008/0093927 A1
(43) Pub. Date: Apr. 24, 2008

(54) MODULAR POWER DISTRIBUTION UNIT SYSTEM

(75) Inventors: Carrel W. Ewing, Reno, NV (US); Andrew J. Cleveland, Reno, NV (US); James P. Maskaly, Sparks, NV (US); David Greenblat, Carson City, NV (US); Brandon W. Ewing, Reno, NV (US)

Correspondence Address: HOLLAND & HART, LLP, P.O BOX 8749, DENVER, CO, 80201, US

(73) Assignee: Server Technology, Inc.

(21) Appl. No.: 11/858,841

(22) Filed: Sep. 20, 2007

Related U.S. Application Data
(60) Provisional application No. 60/846,198, filed on Sep. 20, 2006.

(51) Int. Cl. H02J 3/00; H02B 1/24

(52) U.S. Cl. 307/23; 361/622

(57) ABSTRACT

Embodiments of a power distribution system for distributing power to one or more electronic components, such as electronic components mounted within an electronic equipment rack, can include a dedicated controller mountable within a power distribution rack and at least one power distribution unit electrically coupleable to the controller and mountable at any of various locations within the rack. In certain embodiments, the controller can receive power from a power source and intelligently distribute the power to power distribution units coupled to the controller. The power distribution units can include outputs or receptacles to which power cords of electronic equipment stored in the rack can be coupled and through which power can be transmitted from the power distribution units to the electronic equipment.

### CROSS REFERENCE TO RELATED APPLICATION

This application claims priority to, and the benefit of, U.S. Provisional Application No. 60/846,198, filed on Sep. 20, 2006, which is incorporated herein by reference in its entirety.

### BACKGROUND

Electronic equipment racks, such as standard RETMA racks, commonly consist of rectangular or box-shaped housings sometimes referred to as a cabinet or a rack. Electronic equipment is commonly mountable in such racks so that the various electronic devices are aligned vertically one on top of the other in the rack. Often, multiple such racks are oriented side-by-side, with each containing numerous electronic components and having substantial quantities of associated component wiring located both within and outside of the area occupied by the racks.

Power distribution units have long been utilized to supply power to the electronic equipment in such racks and to remotely monitor and control the supply of power to the electronic equipment.

As shown in FIGS. 1 and 7, conventional racks, such as rack 100, are typically cube-shaped or box-shaped and include at least four spaced-apart vertical support members, such as front vertical members 110, 120 and rear vertical members 130, 140 that extend parallel to each other. Bottom portions of the vertical support members are interconnected by at least four bottom horizontal support members, such as side bottom support members 160, 162, front bottom horizontal support member (not shown) and rear bottom horizontal support member 180. The side bottom support members 160, 162 extend generally parallel to each other and the front and rear bottom horizontal support members extend parallel to each other to define a generally square or rectangular shaped bottom side 190 of the rack.

Similarly, top portions of the vertical support members are interconnected by at least four top horizontal support members, such as side top support members 200, 202 front top horizontal support member 210 and rear top horizontal support member 220. The side top support members 200, 202 extend generally parallel to each other and the front and rear top horizontal support members 210, 220 extend parallel to each other to define a generally square or rectangular shaped top side 230 of the rack. The bottom horizontal support members and the top horizontal support members extend generally parallel to each other.

Generally, the rack 100 includes two sides 260, 262, a front side 270 and a rear side 272. Side 260 includes the area of the rack defined between the side top support member 200, front vertical member 110, rear vertical member 130, and side bottom support member 160. Similarly, the side 262 includes the area of the rack defined between the side top support member 202, front vertical member 120, rear vertical member 140, and side bottom support member 162. The front side 270 includes the area of the rack defined between the front top support surface 210, front side support members 110, 120 and the front bottom support member. The rear side 272 includes the area of the rack defined between the rear top support surface 220, the rear side support members 130, 140 and the rear bottom support member 180. Moreover, the rack include an interior portion 290 defined between the bottom side 190, top side 230, two sides 260, 262, front side 270 and rear side 272.

Conventional racks can also include one or more intermediate horizontal support members, such as intermediate horizontal support members 240, 250 coupled to two adjacent vertical support members at a location between the bottom and top horizontal support members. For example, intermediate horizontal support member 240 extends horizontally from front vertical support member 110 at a first end to rear vertical support member 130 at a second end.

Conventional racks, which are generally similar in form to the racks shown in FIGS. 1 and 7, can include one or more electronic equipment support members 242. The electronic equipment support members 242 can extend generally parallel to the vertical support members with each electronic equipment support member being positioned proximate a respective one of the vertical members. The electronic equipment support members 242 are configured to support one or more pieces of electronic equipment within the rack. For example, shelves (not shown) can be mounted to and spaced-apart vertically along the electronic equipment support members 242. The shelves can then be used to support one or more electronic equipment components.

Common power distribution units for use with an electronic equipment rack generally consist of an elongated box-type housing that has one or more power inputs and a number of power outputs extending along a longitudinal face of the units. Such conventional power distribution units are designed to be vertically mounted within the confines of a rack and have an overall length such that the power distribution units typically extend along a substantial height of the racks, e.g., a distance between the bottom and top portions 190, 230, respectively, of the racks.

Often, because of the substantial length of conventional power distribution units, such units are configured to negotiate or accommodate the presence of intermediate horizontal support members. Moreover, the general shape and configuration of the power distribution units can be limited by the intermediate horizontal support members.

Conventional power distribution units are also designed to be mounted at a particular predetermined location within the rack, such as proximate a rear portion of the rack. Typically, the predetermined location within the rack is unalterable. In other words, conventional power distribution units designed for mounting in a predetermined location cannot be mounted in other locations within the rack, such as to accommodate future changes in electronic equipment and electronic equipment stacking configurations within the rack.

### SUMMARY

Described herein are several examples of embodiments of a power distribution system for distributing power to one or more electronic components, such as electronic components mounted within an electronic equipment rack. In some aspects, the power distribution system includes a dedicated controller (such as a 60 A, three-phase controller, for example) mountable within a power distribution rack and at least one power distribution unit electrically coupleable to the controller and mountable at any of various locations within the rack. In specific implementations, the controller receives power from a power source and intelligently distributes the power to power distribution units coupled to the controller. The power distribution units can include outputs or receptacles to which power cords of electronic equipment stored in the rack can be coupled and through which power is transmitted from the power distribution units to the electronic equipment.

In contrast to conventional power distribution units, in some implementations, the controllers and power distribution units of the power distribution system described herein are not confined to particular predetermined locations within the racks and do not require structural modifications to accommodate the various support members of the rack. Rather, in some aspects, the dedicated controller can facilitate power distribution to multiple power distribution units of various sizes and types mounted at any of various orientations and locations within a rack to more conveniently receive power plugs of electronic equipment mounted in the rack. In other words, the power distribution system can facilitate flexibility in the location of power outlets relative to the location of electronic equipment within the rack to enhance the accessibility of the power outlets to the power cords of the electronic equipment.

For example, controllers and conventional rack-mounted power distribution units are typically vertically mounted to accommodate for the length of the units. Such an arrangement provides many advantages, such as the ability to mount a controller on only a single vertical member rather than, for example, two vertical members. The smaller size and flexible mounting of the power distribution units of the power distribution system of some implementations, can allow for horizontal or diagonal mounting within a rack. In certain embodiments, the power distribution units can be mounted such that the outlets face outward at the back of the rack, thereby providing easy access to the outlets.

In certain aspects, the power distribution system provides smaller power distribution units than conventional rack-mounted power distribution units without reducing the number of power outlets available within the racks. For example, multiple power distribution units can be coupled to the controller. Accordingly, although in some implementations the power distribution units are smaller, and thus may have fewer power outlets per unit, than conventional rack-mounted power distribution units, the added functionality of a rack-mounted controller allows for monitoring of multiple power distribution units, which collectively can provide at least the same number of power outlets as conventional rack-mounted power distribution units.

In some aspects, the controller can monitor power to the power distribution units of the system such that the circuitry and other electronic devices required for monitoring power need not be located within each power distribution unit housing. Therefore, space conventionally reserved for monitoring devices and circuitry can be used for other purposes or the size of the modular power distribution unit housings can be reduced. Moreover, in some implementations, with the power monitoring functionality located within a dedicated controller, the controller can monitor current to any of various preexisting or later-developed power distribution units not having power monitoring functionality.

In certain implementations, each of the multiple power distribution units can be individually controlled by the controller. For example, the controller can intelligently control power to the power distribution units of the system, which can allow for space within the power distribution units generally reserved for intelligent power control devices to be utilized for other functionality or a reduction in the overall size of the power distribution units. In specific aspects, the controller can control current to any of various preexisting or later-developed unintelligent power distribution units

In some implementations, the power distribution system can include a master controller mounted within a rack and electrically coupled to a first set of power distribution units and a slave controller mounted within the rack and electrically coupled to a second set of power distribution units. The master controller can control and monitor the operation of the slave controller.

In some implementations, the modular power distribution units can include branch circuit protection such as, for example, at least one on-board fuse to protect each receptacle or set of receptacles against power faults.

In some implementations, a controller can include a three-display board electrically coupled to a remote monitoring assembly. The board can support, for example, one channel of environmental operating condition (e.g., temperature and/or humidity) sensing (e.g., using a sensor) and support an auxiliary device link port, such as interface, or port. The displays (e.g., LED displays) can be electrically coupled to the board for visually communicating the level of current being transmitted to the respective outlets and thus the totalized combined current of each power distribution unit. In certain implementations where power distribution units are vertically mounted such that they face outward from the rear of the rack, for example, the displays are advantageously easily and readily viewable by a user.

In certain implementations, a controller can include one or more intelligent power modules electrically coupled to the outlets and, where there is a master controller, the master controller. The intelligent power modules can be remotely operated via a master controller to control power to one or more power distribution units. Alternatively, each power distribution unit can include one or more intelligent power modules to control power to individual power receptacles or groups of power receptacles housed in the power distribution units.

In a preferred embodiment, a controller is mounted within the interior of a rack in a vertical orientation (i.e., with the length of the housing extending in a generally transverse direction relative to the bottom side of the rack), such that the front panel and the outlets face the rear side of the rack. In certain embodiments, the controller is mounted to the bottom support member and positioned at a bottom rear corner of the rack.

The foregoing features and advantages of the power distribution system are merely examples. The features and advantages described above, as well as other features and advantages, will become more apparent from the following detailed description.

### BRIEF DESCRIPTION OF THE DRAWINGS

FIG. 1 shows one embodiment of a power distribution system mounted within an electronic equipment rack.

FIG. 2 shows one embodiment of a power controller having a power controller housing, power outputs, and current level indicators.

FIG. 3 shows one embodiment of a power distribution unit having a power distribution housing and two sets of power receptacles.

FIG. 4 shows one embodiment of power controller circuitry within a power controller housing.

FIG. 5 shows one embodiment of power distribution unit circuitry within a power distribution unit housing.

FIG. 6 shows an embodiment of a power distribution system mounted within an electronic equipment rack.

FIG. 7 shows a second view of the FIG. 1 embodiment of a power distribution system mounted within an electronic equipment rack.

FIG. 8 shows an embodiment of a slave controller, such as can be used in conjunction with a master controller.

### DETAILED DESCRIPTION

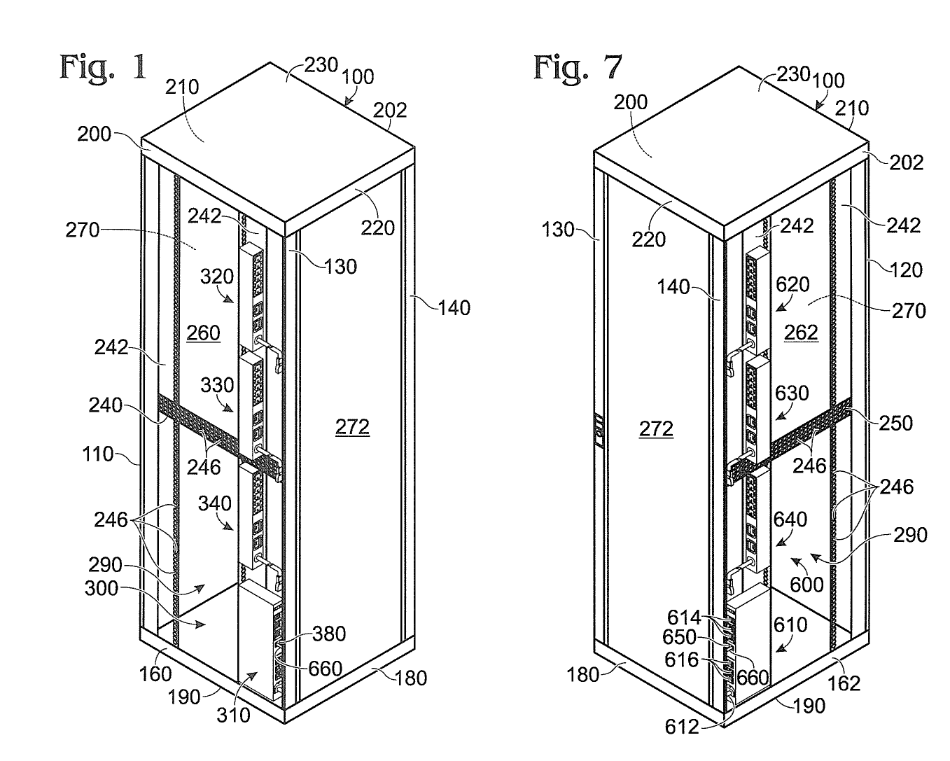

Referring to FIG. 1, a power distribution system 300 is shown mounted within the electronic equipment rack 100. In the illustrated embodiment, the power distribution system 300 includes a controller 310 and three modular or satellite power distribution units 320, 330, 340 each separately and individually electrically coupled to the controller 310. The controller 310 and modular power distribution units 320, 330, 340 are separate and physically distinct from each other. Moreover, the modular power distribution units 320, 330, 340 are movable relative to each other and the controller 310.

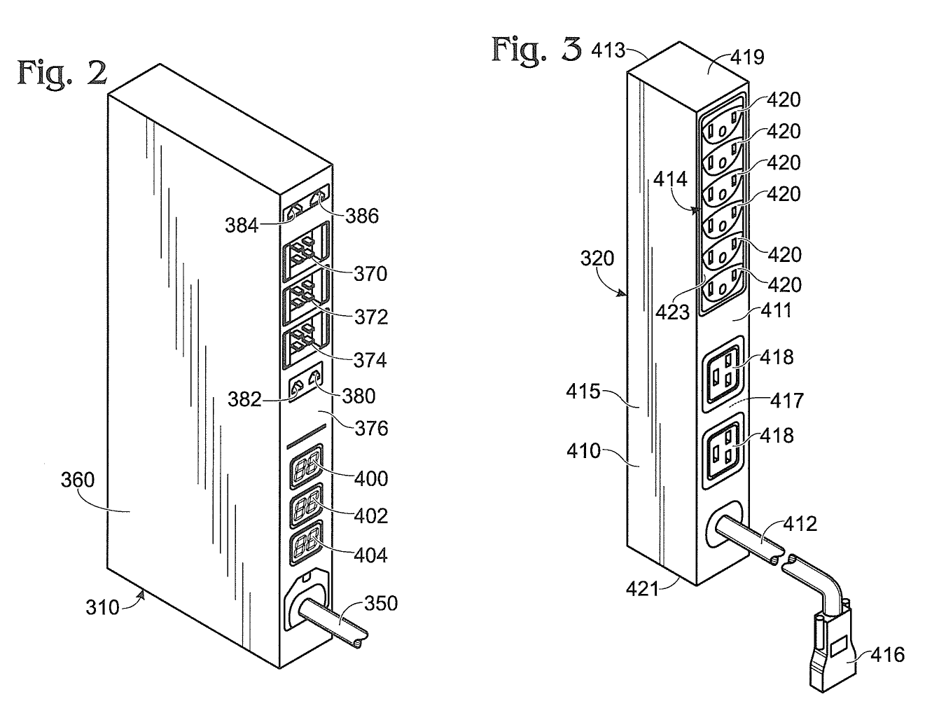

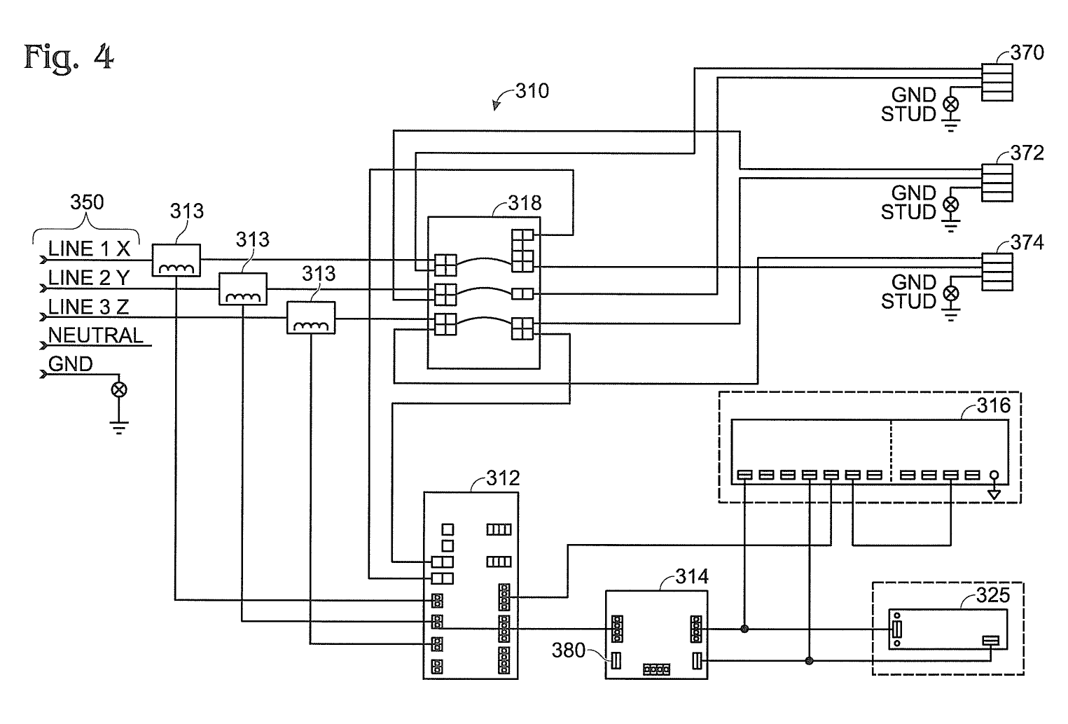

The controller 310 is adapted to receive one or more polyphase, or single-phase, power inputs and includes one or more power outputs. For example, as shown in FIG. 2, the controller 310 includes a housing 360 that receives an input power cord 350 that transmits three-phase power from a three-phase alternating current source (not shown). The three phases provided through the input power cord 350 can arbitrarily be referred to as phases X, Y, and Z. As will be explained in more detail below with reference to FIG. 4, circuitry in the housing 360 divides the three phase alternating current into three single phase power lines each providing single phase power to respective outputs, or outlets, 370, 372, 374 penetrating a front panel 376 of the housing 360.

The housing 360 can include a generally thin rectangular-shaped box having a length substantially greater than its width. The front panel 376 of the housing 360 extends the length of the housing. In implementations, the length of the housing 360 is substantially less than a vertical distance between the bottom side support members 160, 162 and the respective horizontal support members 240, 250, and a vertical distance between the horizontal support members and respective top side support members 200, 202. In certain implementations, up to six horizontal support members may be used in a single rack.

The controller 310 includes current monitoring elements for monitoring the transmission of current from the power source to power distribution units electrically connected to the power outputs 370, 372, 374 and thus to electronic equipment coupled to the power distribution units. For example, as shown in the wiring schematic of FIG. 4, according to one embodiment, controller 310 includes a remote monitoring assembly 312 coupled to current input sensors 313 for remotely monitoring the input current to the controller and thus the output current to the power distribution units.

Controller 310 can also include a three-display board 314 electrically coupled to the remote monitoring assembly 312. The board 314 can support one channel of temperature and humidity sensing and support an auxiliary device link port, such as interface, or port, 380 described below.

The controller 310 can also include a distribution board 318 for distributing current from the input 350 to the outlets 370, 372, 374.

Accordingly, the controller 310 includes components for monitoring of power transmission from a power source to electronic equipment via one or more power distribution units (as will be described in more detail below).

In some embodiments, the controller can include either a master control board 316 and operate as a master controller or have a slave control board 325 and operate as a slave controller. For example, as will be described in more detail below, controller 310 can include a master control board 316 and operate as a master controller to control a slave controller, such as slave controller 610 shown in FIG. 7, having a slave control board 325. In certain implementations, a single controller can include both a master control board and a slave control board and be selectively operable as a master controller or a slave controller.

Although not shown, in some embodiments, the controller 310 can include one or more intelligent power modules electrically coupled to the outlets 370, 372, 374 and the master controller 310. The intelligent power modules can be remotely operated via the master controller 310 to control power to one or more of the power distribution units. Moreover, in some implementations, each power distribution unit can include one or more intelligent power modules to control power to individual power receptacles or groups of power receptacles housed in the power distribution units.

Referring to FIG. 2, the controller 310 can also include three current level indicators, displays or metering devices, 400, 402, 404 electrically coupled to the board 314 for visually communicating the level of current being transmitted to the respective outlets 370, 372, 374, and thus the totalized combined current of each power distribution unit 320, 330, 340. In some implementations, the current level indicators can be an LED display.

The controller 310 can also include one or more interfaces, or ports, adapted to receive communication lines for facilitating communication with external devices. For example, the board 314 can include an auxiliary controller interface, or port, 380 configured to facilitate electrical communication between the controller 310 and the secondary, or slave, controller 610 as will be described in more detail below (see FIG. 7). Referring to FIG. 2, other interfaces or ports, such as environmental sensor port 382, serial communication port 384 and network port 386, can be used to electrically couple the controller 310 to various external devices, such as environmental sensing devices, data communications equipment, and network computing equipment, respectively. In other embodiments, the controller 310 can include other ports for facilitating communication with other external devices.

Referring back to FIG. 1, in some implementations, such as shown, the controller 310 is mounted within the interior 290 of the rack 100 in a vertical orientation, i.e., with the length of the housing 360 extending in a generally transverse direction relative to the bottom side 190 of the rack, such that the front panel 376 and the outlets 370, 372, 374 face the rear side 272 of the rack. As shown in FIG. 1, the controller 310 is mounted to the bottom support member and positioned at a bottom rear corner of the rack. Referring to controller 610 in FIG. 7, which will be described in more detail below, a controller can also be mounted in a vertical orientation at an opposite bottom rear corner of the rack.

Although the controllers 310, 610 are shown as being mounted proximate the bottom rear corners of the rack 100 in a vertical orientation, in other embodiments, a controller of the present disclosure can be mounted in other locations within the rack in a vertical or horizontal orientation. For example, in specific implementations, a controller can be mounted proximate one of the upper rear corners of the rack 100 in a vertical orientation. In other specific implementations, a controller can be mounted along the bottom support member 180 adjacent the rear side 272 of the rack 100 in a horizontal orientation.

With particular reference to FIG. 3, power distribution unit 320 being exemplary of power distribution units 330, 340, the modular power distribution units each include a power distribution unit housing 410. In certain implementations, the housing 410 has a generally elongate rectangular shape having a front panel 411, a rear panel 413 extending generally parallel to and opposite of the front panel, and two side panels 415, 417 extending generally parallel to each other and transversely to the front and rear panels. The housing also has two end portions 419, 421 extending transversely to, and located at opposite ends of, the front, rear and side panels of the housing. In other implementations, the shape of the housing 410 can have an elongate, or non-elongate, shape other than rectangular.

The housing 410 has a length defined as the distance between the ends 419, 421 of the housing. As will be described in more detail below, in many embodiments, the length of the housing 410 is less than the distance between the bottom side support members 160, 162 and the respective horizontal support members 240, 250, and a vertical distance between the horizontal support members and respective top side support members 200, 202. In some embodiments, the length of the housing 410 is less than half of these distances.

For example, in one specific implementation, power distribution unit 320, being exemplary of the power distribution units of the power distribution system 300, can have a length of approximately 347 mm, a width of approximately 44 mm, and a thickness of approximately 57 mm.

Each modular power distribution unit 320, 330, 340 is in power receiving communication with a power input. For example, as shown in FIG. 3, each modular power distribution unit 320, 330, 340 includes a power input cord 412 penetrating the front panel 411 of each housing. The power input cord 412 of each modular power distribution unit includes a plug 416 configured to matingly engage, e.g., plug into, a respective one of the power outputs 370, 372, 374 of the controller 310. When the plugs 416 are engaged with the power outputs 370, 372, 374, transmission of power from the controller power outputs to the power distribution units 320, 330, 340 via the power input cords can be monitored by the controller.

As discussed above, in some embodiments, the controller can have intelligent power control devices, such as intelligent power modules, such that the controller can intelligently control power to individual power distribution units plugged into the power outputs 370, 372, 374. Intelligently controlling power to power receptacles of power distribution units is commonly known in the art. However, such intelligent control is typically performed within the individual power distribution units. In other words, the circuitry and other electronic devices required for intelligently controlling power to power receptacles typically reside within the power distribution unit.

Relocating the functionality associated with power monitoring according to some implementations, intelligent control of power according to other implementations, and power monitoring and intelligent control of power according to yet other implementations, to a dedicated controller can allow new or existing power distribution units to be monitored, intelligently controlled, or monitored and intelligently controlled, by being plugged into the outputs of the controller. Accordingly, the controller of the present disclosure can, if desired, monitor, control, or monitor and control, current to any of various preexisting or new unintelligent or intelligent power distribution units.

Moreover, without the need for monitoring or intelligently controlling power within the power distribution units themselves, space reserved for monitoring or intelligent power devices and circuitry can be used for other purposes or the size of the modular power distribution unit housings can be reduced. Smaller power distribution unit housings can allow for greater flexibility in how and where the power distribution units are mounted within an electronic equipment rack.

Although a power distribution system with a dedicated controller can provide certain advantages, in some embodiments, one or more of the power distribution units of the power distribution system can be an intelligent power distribution unit that has power monitoring devices, intelligent power control devices, or both. In some such embodiments, the controller can be adapted to have limited intelligent power control functionality or, in some cases, no intelligent power control functionality.

Each modular power distribution unit 320, 330, 340 also includes one or more power outputs, outlets, or receptacles penetrating the front panel 411 of each housing 410. For example, in some implementations, such as shown in FIG. 3 and with reference to modular power distribution unit 320, each modular power distribution unit includes a first set of power receptacles 418 and a second set of power receptacles 420. The power receptacles are configured to receive a respective electrical power plug of the electronic equipment mounted within the rack 100. By example, the first set of power receptacles 418 includes two IEC C19-type power receptacles and the second set of power receptacles 420 includes six IEC C13-type power receptacles. In other embodiments, the receptacles of the power distribution units can be any of various NEMA (e.g., NEMA 5-20R, NEMA 5-15R, NEMA 6-20R, NEMA 6-30R or NEMA 6-50R), IEC, or other types of outlets or outputs.

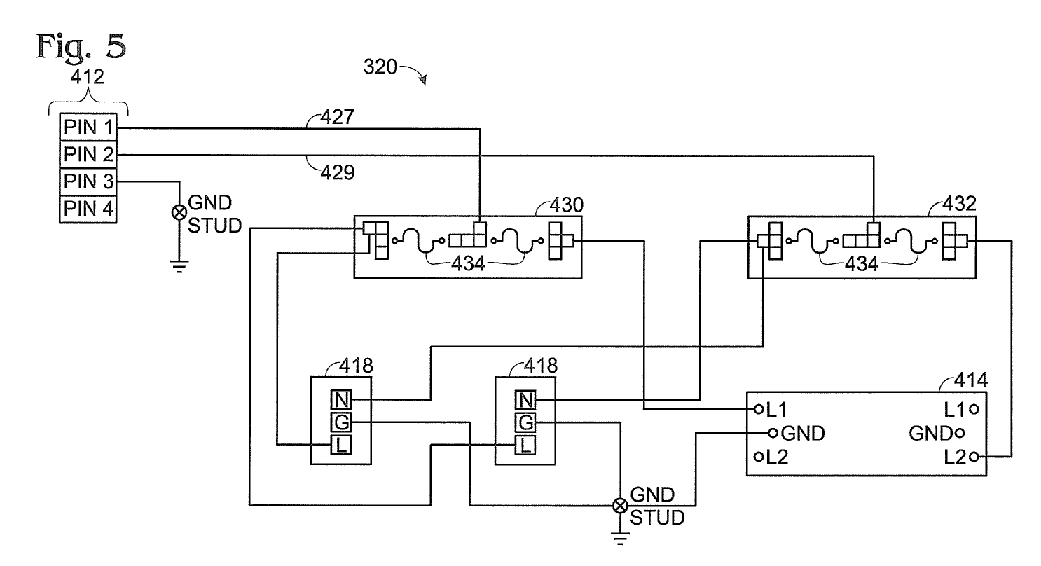

In some embodiments, the receptacles 418 of the first set are interconnected with each other and the receptacles of the second set 420 are interconnected with each other. For example, as shown in FIGS. 3 and 5, the power receptacles 420 of the second set can be interconnected together within a housing 423 to form a ganged outlet module 414.

Although the illustrated embodiment of FIGS. 1 and 3 show a first set of power receptacles 418 having two receptacles of a first type and a second set of power receptacles having six receptacles of a second type, in other embodiments, the modular power distribution units can include more or less than two sets of receptacles with each set having the same type or different types of receptacles. Moreover, each set of receptacles can have fewer or more than two receptacles or more or fewer than six receptacles. In other words, each modular power distribution unit of the present disclosure can have any number of receptacles in any number of configurations.

Each receptacle, such as receptacles 418, 420, penetrating the power distribution units 320, 330, 340 is in power receiving communication with the power input cord 412 such that power can be transmitted from the power source to the individual receptacles via the power input cord 350, power outputs 370, 372, 374, and power input cords 412. In this manner, when a power cord plug of a piece of electronic equipment is engaged with, or plugged into, a respective receptacle of a respective modular power distribution unit, power can be transmitted from the power source to the electronic equipment.

In certain embodiments, each modular power distribution unit 320, 330, 340 includes at least one on-board fuse to protect each receptacle or set of receptacles against power faults. For example, as shown in FIG. 5, in specific embodiments, the power distribution units, e.g., power distribution unit 320, can include a first line fuse board 430 and a second line fuse board 432 each having a pair of fuses 434 mounted thereon.

As shown in FIG. 4, in some embodiments, the input power to the controllers, such as controller 310, is 208V three-phase line-to-line input power, i.e., the input power includes three line, or hot, components, a ground component, and no neutral component. Two of the three line components are electrically coupled to each of the respective power outputs 370, 372, 374 to transmit 208V power to each of the power distribution units. Referring to FIG. 5, one of the two line components electrically coupled to each power distribution unit, e.g., line component 427, is electrically coupled to the fuses 434 of the first line fuse board 430 and the other of the line components of the input power source, e.g., line component 429, can be electrically coupled to the fuses of the second line fuse board 432. In this manner, each line component can be individually fused and protected against power faults.

In some implementations, the input power to the controllers is a 208V three-phase line-to-neutral power input, i.e., the input power includes three line, or hot, components, a ground component, and a neutral component. Each of the three line components and the neutral component is electrically coupled to a respective one of the controller outputs to transmit 120V power to each of the power distribution units. In these implementations, the fuses of the second board 432 in each power distribution unit are replaced by electrical shunts. Accordingly, for each power distribution unit, the single line component is electrically coupled to the fuses 434 of the first fuse board 430 and the neutral component, e.g., neutral return line, is electrically coupled to the electrical shunts of the second fuse board 432 to maintain the integrity of the neutral return line.

Although not shown, in some embodiments, the power distribution units do not include fuse boards and the receptacles of the modular power distribution units 320, 330, 340 can be protected against power faults by being electrically connected to fuses located within the controller housing 360.

In the illustrated embodiments, the input power to the controllers is 30-Amp input power. However, in other embodiments, the input power can be less than 30-Amp input power, such as 20-Amp input power, or more than 30-Amp input power, such as 60-Amp input power.

The modular power distribution units 320, 330, 340 can be mounted in any of various locations within or external to the electronic equipment rack 100. As shown in FIG. 1, in one specific implementation, the modular power distribution units 320, 330, 340 are each mounted in a vertical orientation along the electronic equipment support member 242. In some racks, such as rack 100, the electronic equipment support members 242 each include a series of multiple cut-outs 246 extending a length of the members.

Although not shown, the modular power distribution units 320, 330, 340 can include brackets securable to the housings 360. The brackets can be configured to engage one or more of the cut-outs in the electronic equipment support members 242 to support the power distribution units in place. For example, the brackets can have one or more hooks. The brackets can be configured for easy disengagement from the cut-outs of the electronic equipment members such that the power distribution units can be easily removed and remounted at another location along the same or other electronic equipment support member, or other member of the rack having similar cut-outs. In some embodiments, the brackets can be attached to or integral with the housings 360 and, in some embodiments, the brackets can be configured to attach to the electronic equipment support members 242, or other members of the rack, in any of various known or conventional attachment methods. Although brackets have been described, it is recognized that other attachment mechanisms known in the art, such as fasteners, tabs, clips, and buttons (such as when the members of the rack have button-hole patterns formed therein), can be used in addition to or separate from brackets to secure the power distribution units to a rack.

In some embodiments, as shown in FIG. 1, the power distribution units 320, 330 are positioned proximate the side 260 of the rack 100 between the top side 230 and the horizontal support member 240. More specifically, the power distribution unit 320 is positioned intermediate the power distribution unit 330 and the top side 230, and the power distribution unit 330 is positioned intermediate the horizontal support member 240 and the power distribution unit 320. Further, the modular power distribution unit 340 is positioned proximate the side 260 of the rack 100 intermediate the horizontal support member 240 and the controller 310.

The input cords 412 each extend from a respective power distribution unit 320, 330, 340 to a respective receptacle 370, 372, 374 of the controller 310. Power is then transmitted to each power distribution unit 320, 330, 340 via the controller 310 and the input cords 412. As can be recognized, the location of the power distribution units within the rack can be adjustable or repositionable. In other words, one or more of the power distribution units 320, 330, 340 can be flexibly relocated to another position within the rack 100 and still be electrically coupled to the controller 310 via the input cords 412. For example, if desired, or according to a particular application, power distribution unit 320 can be dismounted from the first location shown in FIG. 1 and remounted to the rack 100 at a second location different from its initial location. Moreover, the power distribution unit 320 can be reoriented into a horizontal orientation within the rack without interfering with or being impeded by the various members of the rack 100.

The power distribution units of the disclosed power distribution system 300 need not be configured to accommodate the horizontal members of the rack 100. For example, because the length of each power distribution unit is less than the vertical distance between the bottom side support members 160, 162 and the respective horizontal support members 240, 250, and the vertical distance between the horizontal support members and respective top side support members 200, 202, the housing of the power distribution units do not need to be specifically designed to receive or be mounted to the horizontal members, such as horizontal members, 240, 250, typically associated with conventional electronic equipment racks, such as rack 100.

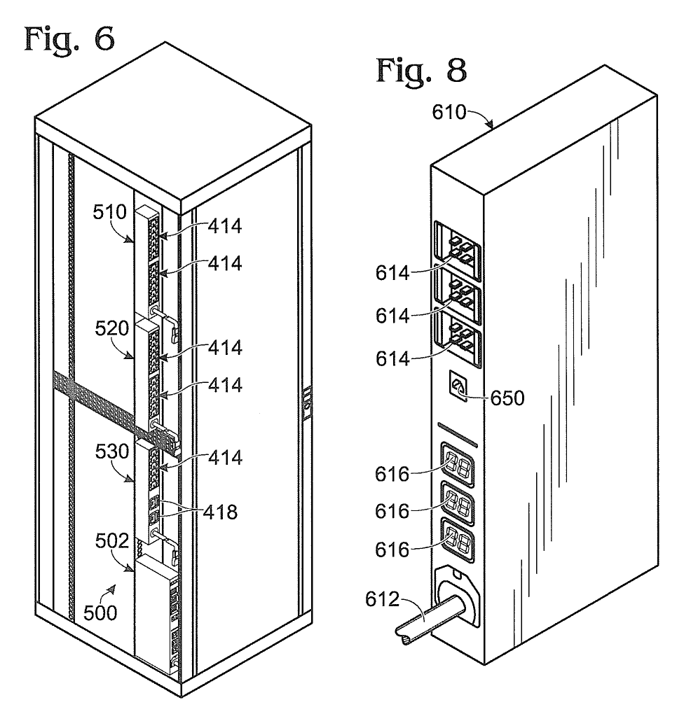

Although the modular power distribution units 320, 330, 340 are of the same type, it is recognized that the power distribution units of a power distribution system of the present disclosure can be of different types. For example, as shown in FIG. 6, power distribution unit system 500 includes three modular power distribution units 510, 520, 530 electrically coupled to controller 502. Power distribution units 510, 520 are of the same type and power distribution unit 530 is of a different type than power distribution units 510, 520. For example, power distribution units 510, 520 are similar to power distribution units 320, 330, 340 except that power distribution units 510, 520 include two power receptacle modules 414. Power distribution unit 530 can be of the same type and configuration as power distribution units 320, 330, 340. Of course it is recognized that modular power distribution units of the present disclosure can be any of various types of power distribution units each individually coupled to and controlled by one or more separate and disparate controllers.

Although the modular power distribution unit system 300 in the illustrated embodiments has three modular power distribution units, in other embodiments, a modular power distribution unit system according to the present disclosure can include fewer or more than three modular power distribution units.

In most implementations, the power distribution system of the present disclosure is mounted within the confines of the rack. However, in some implementations, it is recognized that one or more modular power distribution units can be mounted to the rack at a location outside of the confines of the rack.

In some embodiments, two or more power distribution systems can be mounted within a single electronic equipment rack. For example, referring to FIG. 7, in addition to power distribution system 300, a power distribution system 600 can be mounted within rack 100. Similar to power distribution system 300, power distribution system 600 includes a controller 610 capable of controlling and monitoring power to a plurality of modular power distribution units 620, 630, 640 located at various locations within the rack 100. For example, controller 610 includes an input power cord 612 (e.g., a cord capable of carrying up to 45 A), power outputs 614 and current indicators 616.

In one embodiment, master controller 310 can control slave controller 610 via a connection between the port 380 of controller 310 and a port 650 of controller 610. In some implementations, the connection can be a conventional telephone cord (e.g., an RJ-12 cord), such as telephone cord 660 (see FIGS. 1 and 7). In other implementations, the connection can be another type of cord or cable, such as an Ethernet cable, or communicate in another manner, such as wirelessly.

In some embodiments, the master controller 310 and the slave controller 610 can operate in a master-slave relationship. When connected, the master controller 310 controls, or drives, the slave controller 610 by communicating with the various devices and sensors located on the slave controller. For example, the master control board 316 of the master controller 310 can be electrically coupled to the slave control board 325 of the slave controller via telephone cord 660 to drive the display board 314 of the slave controller and operate the power consumption displays 616 of the slave controller. When disconnected from the master controller 310, the slave controller 610 returns to driving its display board and displays independent of the master controller 310.

Further, when connected, the master controller 310 can operate to transmit information, such as information concerning the power consumption by the slave controller 610, to external devices, such as network devices, via network port 386.

Providing a master controller 310 capable of driving one or more slave controllers 610 can provide certain advantages. For example, such a configuration can allow for increased extensibility or expandability in providing power distribution to electronic equipment located within one or more electronic equipment racks. More specifically, in certain applications, such as when dictated by network constraints, the master controller can be “linked” to the slave controller to effectively provide monitoring for two devices through the interface ports of a single device.

In some implementations, the master controller 310 and slave controller 610 can operate in a master-slave relationship as described in, with particular reference to FIGS. 1, 2A, 2B, 9, and 10 of, U.S. patent application Ser. No. 11/459,011, filed Jul. 20, 2006, which is incorporated herein by reference.

If desired, however, a master controller and a slave controller need not operate in a master-slave relationship and can operate to distribute power independently of each other in the same or different racks.

In view of the many possible embodiments to which the principles of the disclosed modular power distribution unit system may be applied, it should be recognized that the illustrated embodiments are only preferred examples of the system and should not be taken as limiting the scope of the invention.

What is claimed is:

1. An electrical power distribution system of the type being connectable to provide power to one or more electrical loads in an electrical equipment rack, the power distribution system comprising:
at least one power distribution unit (PDU) mountable in the electrical equipment rack, the at least one PDU in power controlling communication with at least one of the plurality of power outputs, the at least one PDU having:
a power input penetrating the PDU; and
a plurality of power outputs disposed in the PDU, wherein each of the plurality of power outputs is connectable to a corresponding one of the one or more electrical loads; and
at least one uninterruptible power supply (UPS) mountable on a member in the electrical equipment rack.

2. The electrical power distribution system of claim 1, wherein the at least one PDU further comprises a PDU communications section.

3. The electrical power distribution system of claim 2, wherein the at least one UPS comprises a UPS communications section.

4. The electrical power distribution system of claim 3, further comprising a command communications link between the UPS communications section and the PDU communications section.

5. The electrical power distribution system of claim 1, wherein one of the at least one PDU is removably mounted in the electrical equipment rack.

6. The electrical power distribution system of claim 1, wherein one of the at least one UPS is removably mounted on a vertical member of the electrical equipment rack.

7. The electrical power distribution system of claim 1, wherein one of the at least one UPS is removably mounted on a horizontal section of the electrical equipment rack.

8. The electrical power distribution system of claim 1, further comprising a dedicated power controller mountable within the electrical equipment rack.

9. The electrical power distribution system of claim 5, wherein the at least one PDU is vertically mounted in the electrical equipment rack.

10. The electrical power distribution system of claim 6, wherein the at least one UPS is vertically mounted on the vertical member of the electrical equipment rack.

11. A method of managing power provided to one or more electrical loads in an electrical equipment rack, the method comprising.
with at least one uninterruptible power supply (UPS) removably mounted in the electrical equipment rack, providing operating power to the one or more electrical loads; and
with at least one power distribution unit (PDU) removably mounted in the electrical equipment rack, managing the operating power provided to the one or more electrical loads.

12. The method of claim 11, further comprising with a communications link between the at least one PDU and the at least one UPS, issuing commands from the at least one PDU to the at least one UPS.

13. The method of claim 11, further comprising with a power controller, monitoring the operating power provided to the one or more electrical loads.

14. The method of claim 11, further comprising monitoring at least one environmental operating condition of at least one of the at least one PDU.

15. The method of claim 14, where the environmental operating condition comprises temperature.

16. The method of claim 14, where the environmental operating condition comprises humidity.
